(19) United States
(12) Patent Application Publication
(10) Pub. No.: US 2006/0029389 A1
(43) Pub. Date: Feb. 9, 2006

(54) Optical network terminal with low power hibernation

(75) Inventors: David Cleary, Bloomington, MN (US); Mark Biegert, Maple Grove, MN (US); Mark T. Paulson, Excelsior, MN (US); Christopher D. Koch, Minneapolis, MN (US)

Correspondence Address: SHUMAKER & SIEFFERT, P. A., 8425 SEASONS PARKWAY, SUITE 105, ST. PAUL, MN, 55125, US

(73) Assignee: Optical Solutions, Inc., Minneapolis, MN (US)

(21) Appl. No.: 11/155,009

(22) Filed: Jun. 16, 2005

Related U.S. Application Data
(60) Provisional application No. 60/598,944, filed on Aug. 5, 2004.

(51) Int. Cl. H04B 10/08

(52) U.S. Cl. 398/33

(57) ABSTRACT

The invention is directed to techniques for reducing power consumption by an optical network transmitter (ONT) in a passive optical network (PON). The techniques may be particularly useful in extending the period of battery powered telephone service during a power outage. In particular, the invention provides a hibernation mode in which power is supplied only to a watchdog circuit while the ONT powers down the optical transmitter, the optical receiver, processing circuitry, data circuitry, video circuitry, and telephone circuitry to conserve power. The watchdog circuit wakes up a subset of the deactivated circuitry at service-critical events in order to service such events, but video and data processing circuitry remain deactivated.

This application claims the benefit of U.S. provisional application No. 60/598,944, filed Aug. 5, 2004, the entire contents of which is incorporated herein by reference.

### TECHNICAL FIELD

The invention relates to optical communication and, more particularly, to techniques for reducing power consumption of network equipment on a passive optical network.

### BACKGROUND

A passive optical network (PON) can deliver voice, video and other data among multiple network nodes using a common optical fiber link. Passive optical splitters and combiners enable a number of optical network terminals (ONTs) to share the optical fiber link. Each ONT terminates the optical fiber link for a residential or business subscriber, and is sometimes referred to as a subscriber premises node. An ONT is connected to one or more subscriber devices, such as televisions, set-top boxes, telephones, computers, or network appliances, which ultimately receive the voice, video and other data delivered via the PON.

Generally, a PON includes a PON interface, sometimes referred to as an optical line terminator (OLT), having multiple, independent PON interface modules that serve multiple optical fiber links. A PON interface module provides an interface for transmission and reception of data packets over a particular optical fiber link that serves a group of ONTs. A PON is inherently a downstream-multicast medium. Each packet transmitted on an optical fiber link can be received by every ONT served by that link. ONTs identify selected packets or frames on the fiber link based on addressing information included within the packets or frames.

Network equipment in a cable or hybrid network may be connected to power provided by a central office, which commonly utilizes battery and generator back-up power to maintain a continuous power supply. In contrast, an ONT in an all-fiber optical network is powered locally at the subscriber premises. In the event of a local power outage, an ONT deactivates power to non-essential services such as voice and data services while maintaining power and service for critical voice service. Typically, an ONT includes a battery to provide back up power during a power outage to maintain critical services. However, battery resources are limited and depend on battery size and the rate of power consumption. Power required for telephony processing tends to be a relatively small part of overall ONT power usage, even when video and data services are deactivated. However, due to the limited amount of power in battery resources, voice service may be available for only a period of several hours following a power failure, even when voice and data services are deactivated.

### SUMMARY

In general, the invention is directed to techniques for reducing power consumption by an optical network transmitter (ONT) in a passive optical network (PON). The techniques may be particularly useful in extending the period of battery powered telephone service during a power outage. In particular, the invention provides a hibernation mode in which power is supplied only to a watchdog circuit while the ONT powers down the optical transmitter, the optical receiver, processing circuitry, data circuitry, video circuitry, and telephone circuitry to conserve power. The watchdog circuit wakes up the deactivated circuitry or, more specifically, a subset of the deactivated circuitry at service-critical events while video and data processing circuitry remain deactivated. In this manner, the ONT invokes a hibernation mode that generally shuts down ONT circuitry to substantially reduce power consumption and thereby extend battery resources to support essential telephone services during a power outage.

When in the hibernation mode, the watchdog circuit is capable of waking up or re-activating the deactivated circuitry at a service-critical event such as an incoming or an outgoing telephone call or for network maintenance communications with an optical line terminal (OLT) on the PON. The watchdog circuit may temporarily power up the optical receiver in order to monitor information to determine occurrences of an incoming call. Then, the watchdog circuit may also re-activate the optical transmitter, processing circuitry, and telephone circuitry when information transmitted to the ONT indicates an incoming telephone call. In addition, the watchdog circuit may monitor a subscriber telephone line to identify an off-hook state, and re-activate the optical receiver, the optical transmitter, the processing circuitry, and the telephone circuitry when the off-hook state is identified to enable a subscriber to place an outgoing telephone call. The watchdog circuit may temporarily re-activate the optical receiver, optical transmitter, and processing circuitry for network maintenance communications with an optical line terminal (OLT).

In one embodiment, the invention provides a method comprising deactivating circuitry within an ONT on a PON when line power to the ONT is disabled, powering a hibernation module within the ONT with battery power when line power to the ONT is disabled, wherein the hibernation module monitors information transmitted to the ONT, and re-activating a subset of the deactivated circuitry when the information transmitted to the ONT indicates a service critical event, wherein the re-activated circuitry is powered with the battery power.

In another embodiment, the invention provides a method comprising deactivating circuitry within an ONT on a PON when line power to the ONT is disabled, powering a hibernation module within the ONT with battery power when the line power to the ONT is disabled, wherein the hibernation module monitors a subscriber telephone line coupled to the ONT to identify an outgoing telephone call, and re-activating a subset of the deactivated circuitry in response to the hibernation module identifying the outgoing telephone call, wherein the re-activated circuitry is powered with the battery power.

In a further embodiment, the invention provides a method comprising deactivating circuitry within an ONT on a PON when line power to the ONT is disabled, powering a hibernation module within the ONT with battery power when the line power to the ONT is disabled, wherein the hibernation module monitors information transmitted to the ONT, and re-activating a subset of the deactivated circuitry to confirm operational status of the ONT when the information transmitted to the ONT indicates a network maintenance communication with an OLT on the PON, wherin the re-activated circuitry is powered with the battery power.

In another embodiment, the invention provides an ONT for use on a PON comprising circuitry that is deactivated when line power to the ONT is disabled, a hibernation module that deactivates the circuitry when the line power to the ONT is disabled, monitors information transmitted to the ONT to detect a service critical event, and re-activates a subset of the deactivated circuitry when in response to detecting the service critical event, and a battery to supply battery power to the hibernation module and the re-activated circuitry when line power to the ONT is disabled.

The invention may offer one or more advantages. Unlike ONTs that employ power conservation measures which provide battery powered telephone services during a power outage for a period of 5-20 hours, the described techniques may extend the period of battery powered telephone service to 10 days or more. Extending the period of critical telephone service delivery in the event of a power failure is important to subscribers. For example, the availability of telephone service may be critical to obtain emergency services. By extending the period of critical service delivery in the event of a power outage, the probability that the outage will last long enough to outlast the power outage and deny service to a subscriber is reduced.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating an exemplary PON suitable for an ONT with a low power hibernation module.

FIG. 2 is a diagram illustrating an ONT with a low power hibernation module in communication with an optical line terminal (OLT) and subscriber equipment.

FIG. 3 is a diagram illustrating a low power hibernation module that detects a service critical event by monitoring information received via an optical receiver or a subscriber telephone line.

FIG. 4 is a flow diagram illustrating operation of a low power hibernation mode in reducing ONT power consumption while monitoring for incoming critical service transmissions.

FIG. 5 is a flow diagram illustrating operation of a low power hibernation mode in reducing ONT power consumption while monitoring for an off-hook telephone state.

FIG. 6 is a flow diagram illustrating operation of a low power hibernation mode in reducing ONT power consumption while confirming on-line status of the ONT to the network.

### DETAILED DESCRIPTION

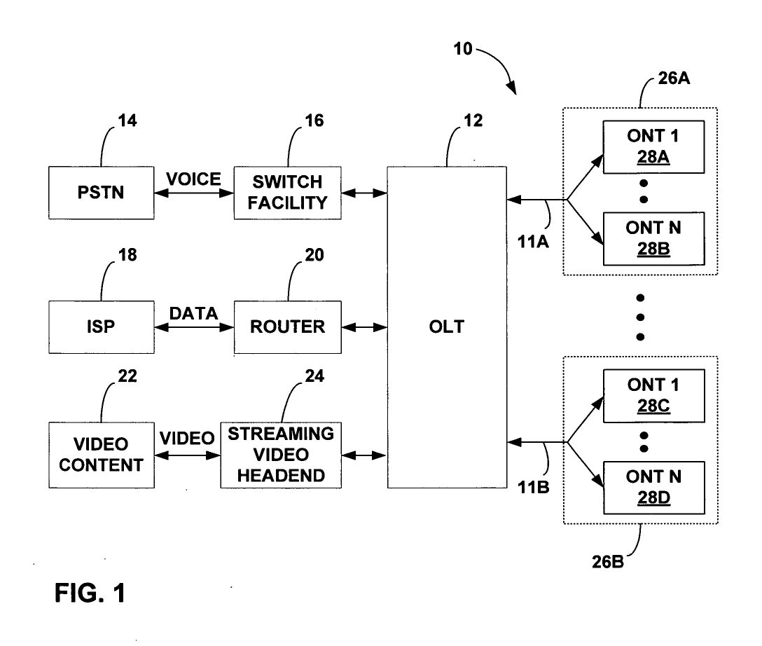

FIG. 1 is a block diagram illustrating a passive optical network (PON) 10. As shown in FIG. 1, PON 10 can be arranged to deliver voice, data and video content (generally “information”) to a number of network nodes via optical fiber links. Exemplary components for implementing a PON are commercially available from Optical Solutions, Inc., of Minneapolis, Minn., and designated by the tradename Fiberpath™, including the Fiberdrive™ headend bay interface, i.e., OLT, and the Fiberpoint™ subscriber premise node, i.e., ONT.

An OLT 12 may receive voice information, for example, from the public switched telephone network (PSTN) 14 via a switch facility 16. In addition, OLT 12 may be coupled to one or more Internet service providers (ISP's) 18 via the Internet and a router 20. As further shown in FIG. 1, OLT 12 may receive video content 22 from video content suppliers via a streaming video headend 24. In each case, OLT 12 receives the information, and distributes it along optical fiber links 11A and 11B (collectively “fiber links 11”) to groups 26A and 26B (collectively “groups 26”) of ONTs 28A, 28B, 28C and 28D (collectively “ONTs 28”). Each of groups 26 is coupled to a respective one of optical fiber links 11. OLT 12 may be coupled to any number of fiber links 11. For purposes of illustration FIG. 1 shows only two fiber links 11A, 11B.

ONTs 28 include hardware for receiving information over PON 10 via optical fiber links 11, and delivering the information to a connected subscriber device, or one or more connected devices. For example, each ONT 28 may serve as a PON access point for one or more computers, network appliances, televisions, set-top boxes, wireless devices, or the like, for video and data services. In addition, each ONT 28 may be connected to subscriber telephones for delivery of telephone services. Hence, ONT 28 may provide video to support television applications, data to support Internet access, and voice to support telephone services. OLT 12 may be located near or far from a group 26 of ONTs 28. In some existing networks, however, OLT 12 may reside in a central office situated within approximately ten miles from each ONT 28.

An ONT 28 may be located at any of a variety of locations, including residential or business sites. In addition, a single ONT 28 may operate on a shared basis to deliver information to two or more closely located residences or businesses via copper or additional optical fiber connections, either directly or via a network hub, router or switch. A group 26 of ONTs 28 may refer to nodes served by OLT 12 via a common optical fiber link 11. Each group 26 in FIG. 1 contains two ONTs 28 for purposes of illustration. However, a group 26 may include a single ONT 28, or numerous ONTs.

ONT 28 also may include hardware for transmitting information over PON 10. For example, an ONT 28 may transmit voice information over PSTN 14 via OLT 12 and switch facility 16 in the course of a telephone conversation. In addition, an ONT 28 may transmit data to a variety of nodes on the Internet via ISP 18, router 20 and OLT 12. ONTs 28 typically transmit upstream over optical fiber links 11 using time division multiplexing techniques, and rely on a downstream grant packet for assignment of upstream time slots to each of ONTs 28.

As will be described in detail, each of ONTs 28 includes a watchdog circuit capable of deactivating circuitry within the ONT following a power line outage to limit power usage of battery backup and re-activating the deactivated circuitry or, more specifically, a subset thereof at service-critical events such as incoming or outgoing telephone calls or for network maintenance communications with OLT 12. Generally, the watchdog circuit deactivates the optical receiver, optical transmitter, data circuitry, video circuitry, and telephone circuitry when line power to the associated one of ONTs 28 is disabled and subsequently re-activates a subset of deactivated circuitry while the data and video circuitry remain deactivated. In particular, the watchdog circuit re-activates the optical receiver, the optical transmitter, the processing circuitry, and telephone circuitry in response to detecting an incoming or outgoing telephone call. In addition, the watchdog periodically re-activates the optical receiver, the optical transmitter, and the processing circuitry to transmit a maintenance communication to OLT 12 to confirm the operational status of the associated one of ONTs 28. In this manner, ONTs 28 invoke a hibernation mode that generally shuts down ONT circuitry to substantially reduce power consumption and thereby extend battery resources to support essential telephone services during a power outage. Consequently, ONTs 28 may extend the period of battery powered telephone services from a period of 5-20 hours to 10 days or more.

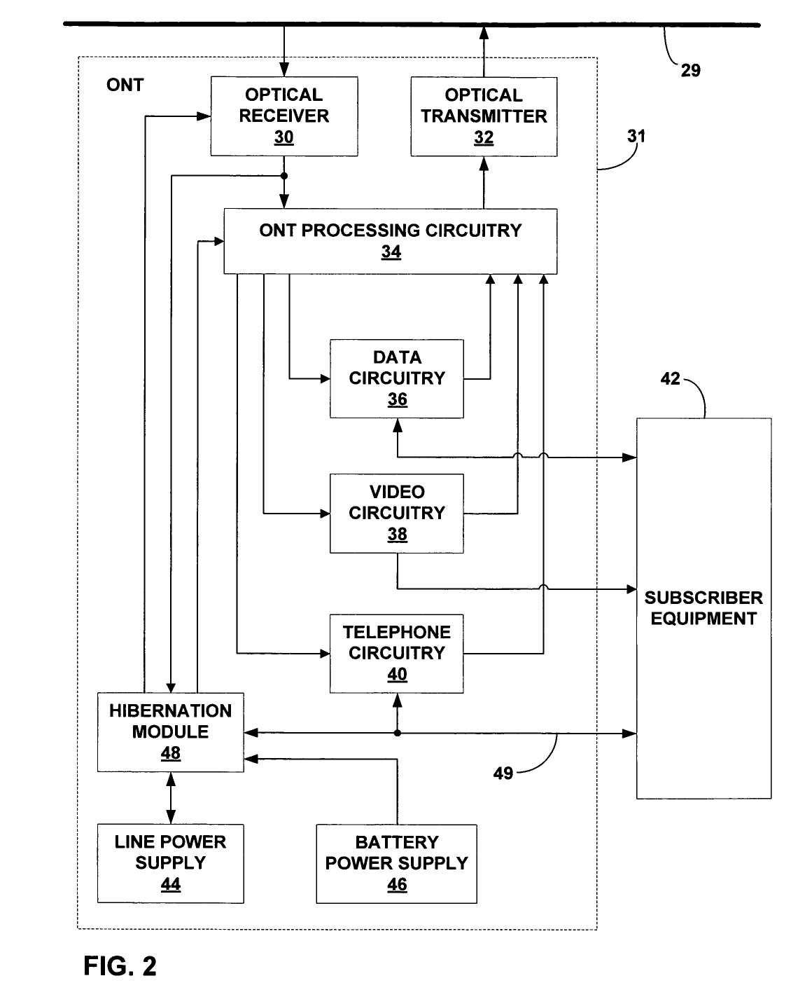

FIG. 2 is a diagram illustrating an exemplary ONT 31 with a lower power hibernation mode in communication with an OLT, such as OLT 12, via optical fiber link 29 and subscriber equipment 42. ONT 31 provides an interface between an optical fiber link 29 on a PON, such as PON 10 shown in FIG. 1, and subscriber equipment 42 in a fiber-to-the-home (FTTH) network. ONT 31 receives information in the form of voice, video and data from the PON over optical fiber link 29 from an OLT on the PON. ONT 31 processes the information to deliver telephone, television and Internet services to subscriber equipment 42. Subscriber equipment 42 may include telephones, computers, televisions, set-top boxes, network applications, and the like. ONT 31 sends video signals to subscriber equipment 42 via coaxial cable, data via network cables such as Ethernet cable, and telephone signals over twisted pair wire. Voice, video and data are examples of information that may be received and transmitted by ONT 31.

As further shown in FIG. 2, to support voice, video and data services, ONT 31 includes an optical receiver 30 that receives optical signals from optical fiber link 29 and converts the optical signals to electrical signals, and an optical transmitter 32 that receives electrical signals from ONT processing circuitry 34 and converts the electrical signals to optical signals for transmission over PON 10 via optical fiber link 29. Optical receiver 30 and optical transmitter 32 form an optical interface, and may be formed by conventional opto-electrical conversion hardware.

ONT processing circuitry 34 handles reception and transmission of information in the form of frames, packets or other units of information over PON 10. For example, ONT processing circuitry 34 may be responsible for identifying information directed to and from particular subscriber equipment 42, and formatting the information to support respective telephone, video or data services within the subscriber premises and over PON 10. Data circuitry 36, video circuitry 38, and telephone circuitry 40 process incoming data for delivery of Internet, television and telephone services, respectively. ONT processing circuitry 34, data circuitry 36, video circuitry 38, and telephone circuitry 40 may be implemented together or separately as one or more microprocessors, digital signal processors (DSPs), application specific integrated circuits (ASICs), field-programmable gate arrays (FPGAs), or other equivalent logic circuitry.

It is generally impractical to power ONT 31 using distributed network power. Consequently, ONT 31 is powered locally with line power supply 44, and also includes a battery power supply 46 for battery backup during power outages. In a power failure, ONT 31 shuts down power to various circuitry for non-essential services. In particular, ONT 31 includes a hibernation module 48 that manages deactivation of various circuitry and re-activation of the deactivated circuitry during a power outage to support a low power hibernation mode. Hibernation module 48 is configured to deactivate various circuitry, and thereby reduce power consumption, while maintaining critical telephone services for the subscriber.

As an example, hibernation module 48 is configured to deactivate optical receiver 30, optical transmitter 32, ONT processing circuitry 34, data circuitry 36, video circuitry 38, and telephone circuitry 40 when line power supply 44 is disabled, such as during a power outage. During the power outage, ONT 31 or, more specifically, hibernation module 48 subsists on power provided by battery power supply 46. Hibernation module 48 generally re-activates a subset of the deactivated circuitry in response to detecting a service critical event. In one embodiment, hibernation module 48 monitors information transmitted to ONT 31 via optical fiber link 29 to identify an incoming telephone call. In another embodiment, hibernation module 48 monitors a subscriber telephone line 49 to detect an outgoing telephone call. In yet another embodiment, hibernation module 48 monitors information transmitted to ONT 31 via optical fiber link to determine when to transmit a maintenance communication to confirm the operational status of ONT 31. In this manner, ONT 31 is able to detect incoming calls even though substantial circuitry is powered down to conserve power. Moreover, unlike conventional battery backup in conventional ONTs, the techniques described herein allow for deactivation of telephone circuitry for substantial periods of time and re-activation of such circuitry only when need to complete an incoming or outgoing telephone call.

To detect incoming calls, hibernation module 48 temporarily re-activates optical receiver 30 at selected intervals to monitor the information transmitted to ONT 31. The selected intervals may be substantially periodic, and may be determined using a synchronized counter within hibernation module 48 or other synchronization mechanism that permits ONT 31 to wake up in synchronization with information transmitted on PON 10. During each interval, the synchronized counter may be resynchronized to PON 10 to support the next wake up interval When hibernation module 48 is monitoring information transmitted to ONT 31 to detect incoming calls, the selected wakeup interval may occur at intervals of greater than or equal to approximately two seconds to help conserve power but less than approximately five seconds to ensure that an incoming call is not missed. In addition, as will be described, ONT 31 may include a preamble comparator to compare an identifier in a preamble in a unit of the information received via fiber link 29 to an identifier associated with the ONT 31, and thereby determine whether the unit of the information indicates a incoming telephone call directed to ONT 31. The preamble comparator may be included within hibernation module 48 or, alternatively, may be the preamble comparator ordinarily used by ONT processing circuitry 34 for normal operation. The unit of information may be a packet, frame or other data structure. In other embodiments, the monitoring circuit may be configured to monitor an upstream grant transmitted to ONT 31 as part of the information to identify the presence of an incoming telephone call. Hibernation module 48 can then re-activate optical transmitter 32, ONT processing circuitry 34, and telephone circuitry 40 to support communication of voice information for the telephone call. In this case, optical receiver 30 is already re-activated to monitor information transmitted to ONT 31, and is therefore ready for use in support of voice communction.

Hibernation module 48 may also, in a similar manner, temporarily re-activate optical receiver 30 at selected intervals to monitor information transmitted to ONT 31 and determine when to send a network maintenance communication to confirm the operational status of ONT 31. However, when hibernation module 48 is monitoring information transmitted to ONT 31 to confirm the its operational status, the selected intervals may occur at intervals of approximately five seconds from one another. Hibernation module 48 may determine when to transmit the network maintenance communication to an OLT by interrogating an upstream grant. Then, hibernation module 48 may re-activate optical transmitter 32, and ONT processing circuitry while data, video, and telephone circuitry 36, 38, and 40, respectively remain deactivated.

Hibernation module 48 also is configured to monitor a subscriber telephone line 49 coupled to subscriber equipment 42. For example, hibernation module 48 may include a line current sensor that monitors electrical current on subscriber telephone line 49 to identify an off-hook state. An off-hook state indicates that the subscriber has lifted the telephone receiver, activated a speakerphone or otherwise activated a subscriber telephone to initiate an outgoing call. In this case, hibernation module 48 responds to the off-hook status by re-activating optical receiver 30, optical transmitter 32, ONT processor 34, telephone circuitry 40 and any other ONT circuitry needed to handle the call.

In general, hibernation module 48 deactivates optical receiver 30, optical transmitter 32, ONT processor 34, data circuitry 36, video circuitry 38 and telephone circuitry 40 to limit power consumption during a power outage, yet temporarily activates optical receiver 30 at selected intervals to detect the occurrence of service critical events, i.e., an incoming phone call or a network maintenance communication. Then, to support telephone services, hibernation module 48 also re-activates optical transmitter 32, ONT processing circuitry 34, and telephone circuitry 40 for operation until the call is completed. Accordingly, hibernation module 48 causes ONT 31 to re-enter the low power hibernation mode, e.g., in response to a call termination signal or an on-hook status observed on subscriber telephone line 49. Hibernation module 48 also causes ONT 31 to re-enter the low power hibernation mode after completion of a network maintenance communication. Data circuitry 36 and video circuitry 38 may remain deactivated at all times during a line power outage, as these services are typically viewed as less critical during a line power outage than telephone services.

In accordance with the invention, ONT hibernation module 48 allows optical receiver 30, optical transmitter 32, ONT processing circuitry 34, data circuitry 36, video circuitry 38 and telephone circuitry 40 to be shut down for a substantial fraction of the time ONT 31 is functioning on back up battery power supply 46. This results in a substantial reduction in the power consumption of ONT 31 while operating in a “hibernation” mode. For example, this reduction in power consumption may at least double the battery backup voice service time in the event of a power outage and, in some cases, may extend battery power to run over several days. Extending the period of critical telephone service delivery in the event of a power outage enables a subscriber obtain emergency services during the power outage. As a result, the probability that the outage will last longer enough to outlast the power outage and deny service to a subscriber is reduced.

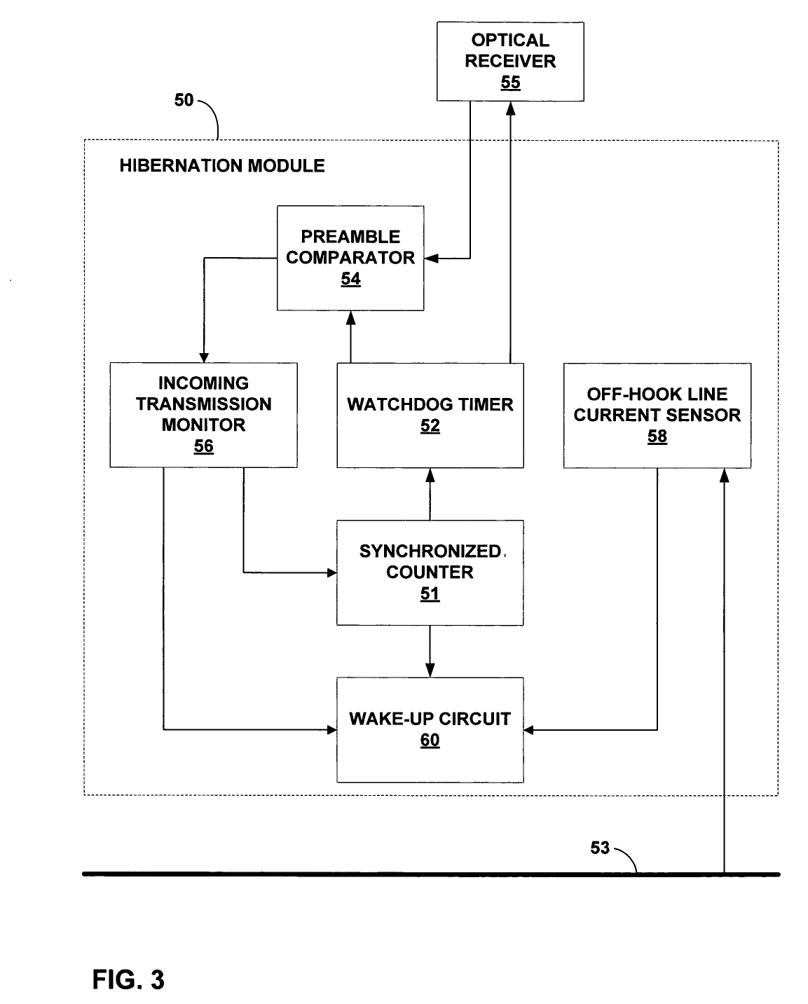

FIG. 3 is a diagram illustrating an exemplary low power hibernation module 50 that detects a service critical event by monitoring information received via an optical receiver 55 or a subscriber telephone line 53. Low power hibernation module 50 may generally be associated with any ONT that may operate in the previously described hibernation mode. Consequently, hibernation module 50 may be associated with ONT 31 of FIG. 2 and, thus, viewed as a more detailed diagram of hibernation module 48. In the example of FIG. 3, ONT hibernation module 50 includes a synchronized counter 51, a watchdog timer 52, a preamble comparator 54, an incoming transmission monitor 56, an off-hook line current sensor 58 and a wake-up circuit 60. Synchronized counter 51 is synchronized to a PON, such as PON 10, and generates an output for comparison to a threshold by watchdog timer 52. When the output of synchronized counter 51 reaches the threshold, watchdog timer 52 generates a signal to temporarily activate preamble comparator 54 and optical receiver 55. Preamble comparator 54 compares an identifier in a preamble of a unit of information received via optical receiver 55 to an identifier corresponding to the ONT associated with hibernation module 50, such as network address, media access control (MAC) address, or other identifier.

Incoming transmission monitor 56 monitors the output of preamble comparator 54 to identify whether there is an incoming call directed to the associated ONT. If so, incoming transmission monitor 56 activates a wake-up circuit 60, which then activates associated ONT circuitry necessary to handle the incoming call. Likewise, off-hook line current sensor 58 activates wake-up circuit 60 when line current indicates an off-hook state to handle the outgoing call. Hibernation module 50 also includes inputs from optical receiver 55 and subscriber telephone line 53 corresponding to incoming network transmissions and attempted outgoing voice telephone calls, respectively. In some embodiments, incoming transmission monitor 56 also may direct the transmission of maintenance information from the ONT associated with hibernation module 50 to an OLT to indicate that the associated ONT is operating properly, and maintain its operational status on the PON. Output from preamble comparator 54 or incoming transmission monitor 56 may also be used to resynchronize counter 51 to the PON, and thereby improve the accuracy of the next selected interval for activation of preamble comparator 54.

In order to significantly reduce power consumption and increase battery-backup service in the event of a power outage, hibernation module 50 allows the associated ONT to go into hibernation mode. In this mode, virtually all electronics may be shut down except for hibernation module 50, which generally forms a low-power watchdog circuit. Furthermore, hibernation module 50 allows the associated ONT to receive and transmit minimally while maintaining its operational status on the PON. When required, hibernation module 50 may be capable of waking or re-activating a subset of the deactivated circuitry to handle other service-critical events.

In general, there are at least three service critical events that may require hibernation module 50 to re-activate a subset of the deactivated circuitry, e.g., at least one of optical receiver 55, the optical transmitter (not shown), the processing circuitry (not shown), and the telephone circuitry (not shown) of the associated ONT thereby causing the associated ONT to be taken out of hibernation mode. However, even when taken out of hibernation mode while functioning on battery back up, non-critical services can remain disabled to reduce power consumption of the associated ONT. The first service critical event occurs when hibernation module 50 detects an incoming voice service transmission. The second occurs when an attempted outgoing voice service transmission (off-hook) is detected. The third event requires a periodic reception of a maintenance packet from an OLT to the associated ONT, and a periodic transmission of a maintenance packet to the OLT from the associated ONT to maintain the operational status of the associated ONT. Specifically, the associated ONT needs to respond to an upstream grant from the OLT at periodic intervals to confirm network integrity to the OLT. Otherwise, the associated ONT may be considered lost, and hence out of service, by the PON. Because incoming and outgoing voice services transmissions are somewhat random events, the OLT and the associated ONT can make periodic communications that allow transactions of these events.

In a PON comprising multiple ONTs, such as PON 10 decribed in FIG. 1, each of the ONTs must be allocated separate upstream transmission grants to avoid contention between upstream transmissions from the other ONTs. Existing PON architectures use at least two types of downstream and upstream framing methods: the gigabit passive optical network (GPON) framing method (per the ITU G.984.3 standard) and the broadband passive optical network (BPON) method (per the ITU G.983.1 standard). In both GPON and BPON, OLT 12 gives a grant to ONT 28 to use for upstream transmission. GPON and BPON use downstream framing formats that are based on a fixed periodic basis. In GPON, upstream grants are given in a packet known as an “upstream bandwidth map.” In BPON, upstream grants are part of the Physical Layer Operations, Administration and Maintenance (PLOAM) packet transmitted by OLT 12.

Synchronized counter 51 is synchronized to the periodic transmission format of the OLT. Counter 51 can be set up for either BPON, or GPON, or both. Specifically, counter 51 indicates when packets are scheduled to be sent to the associated ONT, and may be resynchronized periodically based on ranging data. In effect, counter 51 informs preamble comparator circuit 54, via watch dog timer 52, when to look for the preamble of a downstream frame. This allows comparator 54 to lock onto the preamble of an incoming frame to ensure that the bits received are in the justified and proper placement to maintain synchronization between the associated ONT and the PON. Comparator 54 does not need to analyze all downstream frames, but rather periodically looks at the preamble of an incoming network frame to ensure counter 51 is synchronized with the PON. If comparator 54 finds an error, incoming transmission monitor 56 instructs counter 51 to adjust its timing accordingly.

Synchronized counter 51 of hibernation module 50 allows the associated ONT to look exclusively at selected upstream bandwidth maps (for the GPON protocol) or PLOAM packets (for the BPON protocol), at expected transmission times thereby ignoring the vast majority of downstream traffic and reducing the power consumption of the associated ONT. The selected upstream bandwidth map or PLOAM packet indicates when the associated ONT may transmit to the OLT, which is useful for two of the critical service events: outgoing voice service transmissions and responding to received grants to confirm network integrity to the OLT. However, a selected upstream bandwidth map or PLOAM packet does not generally indicate whether an incoming voice service transmission is available for the associated ONT.

When the associated ONT wakes up on a network-generated request for service, e.g. an incoming call, there are implications for both the associated ONT and the OLT. If the associated ONT periodically wakes up, e.g., every few seconds, in order to search for call indications on the downstream signal, the associated ONT must be able to quickly wakeup, establish a network connection, determine the need for phone service, and then shutdown if there is no request for telephony service. Consequently, the OLT must be able to deal with ONTs that are waking up and shutting down, which may require “pop-up ranging,” a type of ranging that remembers ONTs that have been active on the PON. Alternatively, the associated ONT or hibernation module 50 may use an ultra-low-power optical circuit that can detect the presence of an incoming call on the downstream signal.

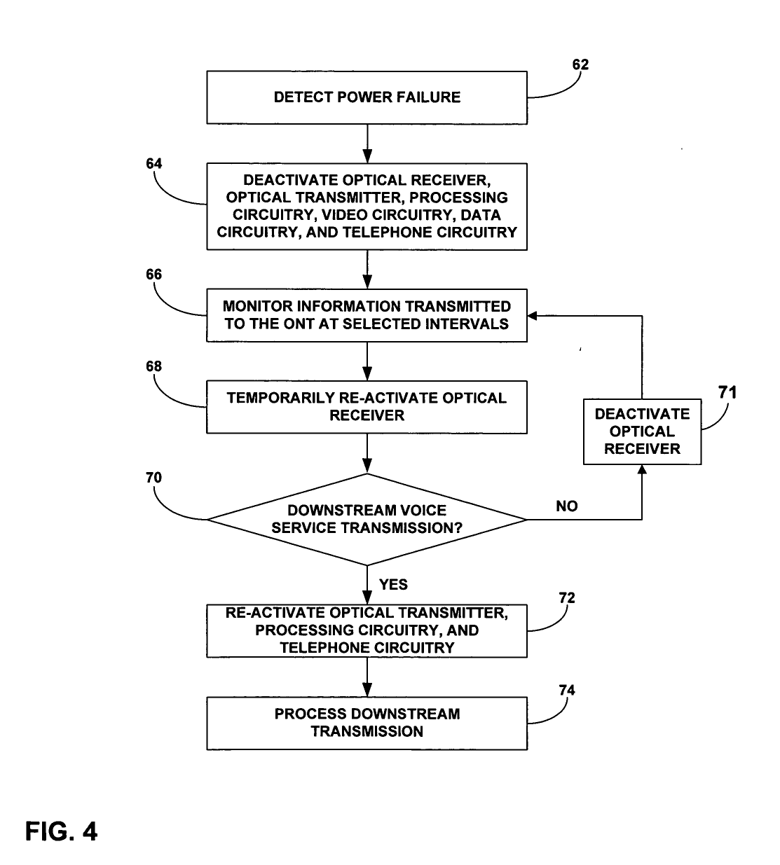

While upstream bandwidth maps and PLOAM packets are not generally useful for indicating an incoming voice transmission, the associated ONT may identify an incoming voice transmission by monitoring upstream bandwidth maps and PLOAM packets. In GPON, for example, the upstream bandwidth map may be “overloaded” to inform the associated ONT of an incoming voice service transmission. In this embodiment, a message is embedded in the upstream bandwidth map by loading one or more empty fields to indicate to the associated ONT that there is an incoming voice service transmission. In BPON, the message may be an explicit message from the OLT informing the associatd ONT about the incoming voice service transmission. Receiving an incoming voice service transmission requires the OLT to repeatedly transmit the incoming voice service transmission message until the associated ONT wakes up, as it is instructed to do periodically by incoming wake-up circuit 60. Once the associated ONT sends a reply message indicating it is ready to receive the transmission, the OLT may then initiate the voice service transmission, in which case appropriate circuitry within the associated ONT is re-activated to handle the call. For example, wake-up circuit 60 may re-activate optical receiver 55, an optical transmitter (not shown), processing circuitry (not shown), and telephone circuitry (not shown) within the associated ONT to handle the call in response to input from incoming transmission monitor 56. Methods for receiving incoming voice service transmissions are discussed further in the description of FIG. 4.

In order to confirm network integrity, the associated ONT is required to respond periodically to an upstream grant from the OLT. Wake up circuit 60 receives an input from counter 51 and periodically wakes up optical receiver 55, the optical transmitter (not shown), and processing circuitry (not shown) within the associated ONT to receive selected upstream bandwidth maps or PLOAM packets. The associated ONT then receives an incoming upstream bandwidth map or PLOAM packet and determines when to transmit to the OLT. The associated ONT then sends a satisfactory reply to the OLT to indicate its operational status. If the associated ONT does not send a periodic reply, the OLT will consider the associated ONT lost and may discontinue transmissions to the associated ONT.

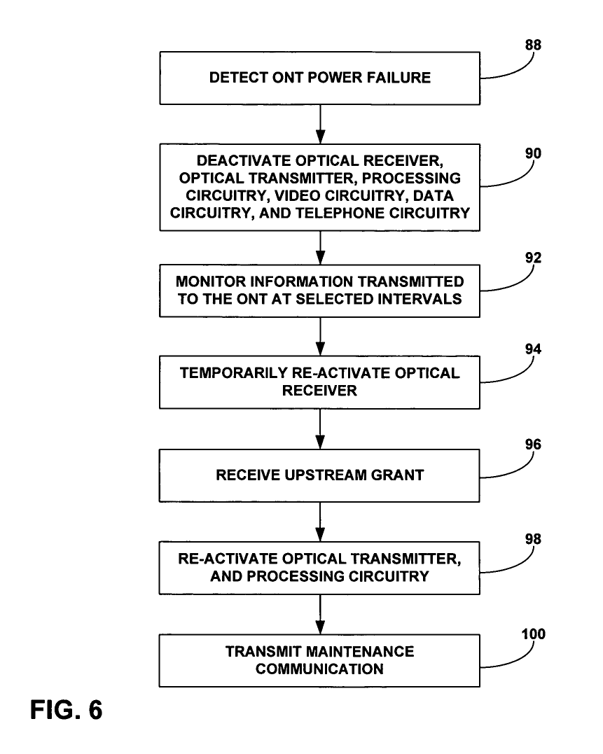

For confirming network integrity while ONTs on the PON are in hibernation mode, the OLT should be able to deal with ONTs that are waking up and shutting down. Consequently, the OLT may use “pop-up ranging,” i.e., a type of ranging in which the OLT remembers which ONTs have been active on the PON. For example, the OLT may track the ONTs known to be in hibernation mode, and require less frequent responses from the ONTs in hibernation mode before considering one of the ONTs lost. Methods for confirming network integrity may be combined with methods for initiating an outgoing voice service transmission in order to increase the fraction of time the associated ONT is in a hibernation mode and further reduce power consumption of the associated ONT. Methods for confirming network integrity are discussed further in the description of FIG. 6.

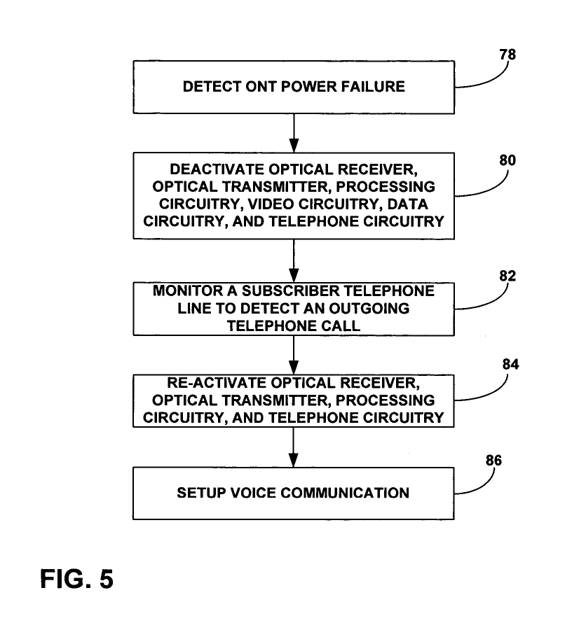

Off-hook line current sensor 58 works independently from counter 51 and comparator 54. When line current sensor 58 senses an off-hook telephone, indicating a subscriber-initiated voice service transmission, sensor 58 causes wake-up circuit 60 to re-activate essential electronic circuitry of the associated ONT to handle the call. For example, sensor 58 may transmit a signal to wake-up circuit 60 to re-activate optical receiver 55, the optical transmitter (not shown), processing circuitry (not shown), and telephone circuitry (not shown) by monitoring the electrical current on subscriber telephone line 53 to identify an off-hook state. The associated ONT then sends a timely response to the OLT to indicate traffic is starting and starts regular voice service with the OLT. After the voice service communication is terminated, the associated ONT returns to hibernation mode. Methods for initiating an outgoing voice service transmission while the associated ONT is in hibernation made are discussed further in the description of FIG. 5.

FIG. 4 is a flow diagram illustrating operation of a low power hibernation mode for reducing ONT power consumption while monitoring for incoming critical service transmissions. First, the ONT detects a power failure (62). Next, a hibernation module deactivates the optical receiver, optical transmitter, processing circuitry, video circuitry, data circuitry, and telephone circuitry (64).

In response to detecting a power failure and deactivating non-essential circuitry, the hibernation module monitors information transmitted to the ONT at selected intervals (66). The selected intervals may be determined by a synchronized counter which keeps the ONT synchronized with an OLT on a PON while the ONT is in hibernation mode. The intervals may be programmed, as desired, but should typically be long enough to ensure power conservation yet short enough to ensure that an incoming telephone call is not missed altogether. The synchronized counter indicates when packets are scheduled to be sent to the ONT and may be configured for either BPON or GPON, or both. In particular, a watchdog timer compares the output of the synchronized counter to a threshold. When the output of the synchronized counter reaches the threshold, the watchdog timer generates an output signal to temporarily activate the optical receiver. Specifically, a wake-up circuit may receive the output signal and temporarily re-activate the optical receiver (68) to receive an incoming transmission. Thus, the optical receiver is activated based on the output of the synchronized timer.

An incoming transmission monitor then determines if the OLT has sent a message alerting the ONT that there is a downstream or incoming voice service transmission (70). The ONT may determine if the OLT has sent a downstream service transmission by comparing an identifier in a preamble unit of information received to an identifier associated with the ONT, such as a network address, MAC address, or other identifier. As described previously, the upstream bandwidth map may be overloaded to inform the ONT of an incoming voice transmission when using GPON while the OLT may transmit an explicit message when using BPON. If there is no such message, the hibernation module deactivates the optical receiver (71) and waits for the next wake-up interval. The ONT may reset or resynchronize the counter using the information received from the OLT to determine the next wake-up interval. However, if the ONT receives a message from the OLT indicating there is an incoming transmission, then the hibernation module re-activates the optical transmitter, processing circuitry, and telephone circuitry (72) and processes the downstream transmission (74), thereby facilitating a two-way voice service communication.

Notably, the method described in FIG. 4 is not the only means for an ONT in hibernation mode to receive incoming transmissions. For example, in another embodiment, a low-power optical circuit may be provided to continuously, rather than periodically, detect the presence of an incoming call on the downstream signal and then immediately wake up the ONT to initiate the voice service transmission.

FIG. 5 is a flow diagram illustrating operation of a low power hibernation mode in reducing ONT power consumption while monitoring for an off-hook state. First, the ONT detects a power failure (78). Next, a hibernation module deactivates the optical receiver, the optical transmitter, processing circuitry, data circuitry, video circuitry, and telephone circuitry (80). An off-hook line current sensor monitors a subscriber telephone line coupled to a telephone to identify an outgoing telephone call by detecting an off-hook line current (82), which generally indicates that a subscriber intends to initiate a voice service transmission. For example, the subscriber may have picked up a telephone handset, activated a speakerphone, or otherwise opened the subscriber telephone line for communication. When the off-hook line current is detected, the hibernation module re-activates the optical receiver, the optical transmitter, processing circuitry, and telephone circuitry (84) by supplying power to the circtuiry. Finally, the ONT sets up the voice service transmission by sending a signal to an OLT over a PON (86).

FIG. 6 is a flow diagram illustrating operation of a low power hibernation mode in reducing ONT power consumption while confirming operational status of the ONT to the network. First, the ONT detects a power failure (88). Next, a hibernation module deactivates the optical receiver, the optical transmitter, processing circuitry, data circuitry, video circuitry, and telephone circuitry (90) to enter the low power hibernation mode.

In response to entering the low power hibernation mode, the hibernation module monitors information transmitted to the ONT at selected intervals (92). Again, the selected intervals may be determined by a synchronized counter that indicates when packates are scheduled to be sent to the ONT and may be configured for either BPON or GPON, or both. Specifically, the ONT needs to respond to an upstream grant from the OLT at periodic intervals to confirm network integrity. Otherwise, the ONT may be considered lost and and the OLT may discontinue transmissions to the ONT. The intervals may be programmed and may be longer than those used to monitor the exisitance of an incoming telephone call. In any case, the ONT does not examine all downstream frames, but rather periodically examines an upstream bandwidth map (GPON) or PLOAM packet (BPON).

Upon activating the synchronized counter and the elapse of a specified period of time, a wake-up circuit may receive an input signal from the synchronized counter to temporarily re-activate the optical receiver (94). The ONT then looks for and receives an upstream grant from the OLT (96). After receiving the upstream grant, the hibernation module determines when to reply to the OLT and re-activates the optical transmitter, and processing circuitry (98) to transmit a maintenance communication (100) to indicate a robust network and prevent the OLT from considering the ONT lost.

Various hardware components described herein may include one or more processors, e.g. one or more microprocessors, digital signal processors (DSPs), application specific integrated circuits (ASICs), field-programmable gate arrays (FPGAs), or other programmable logic circuitry. In addition, in some cases, such components may execute program instructions stored within computer-readable media that cause them to perform the functions ascribed to them herein. Consequently, some embodiments take the form of a computer-readable medium comprising instructions that cause a programmable processor to perform various functions described herein. A computer-readable medium may be any electronic, magnetic, or optical medium, such as a random access memory (RAM), read-only memory (ROM), CD-ROM, hard or floppy magnetic disk, electronically erasable and programmable ROM (EEPROM), flash memory, or the like.

Various embodiments of the invention have been described. However, one skilled in the art will appreciate that various modifications or additions may be made to the described embodiments without departing from the scope of the claimed invention. For example, while the invention is generally described for use in the event of a power outage, it could be used during any operational situation in order to conserve power. In addition, the techniques may find use when other local (non-battery) supplemental power souces are used to back-up line power. These and other embodiments are within the scope of the following claims.

1. A method comprising:
deactivating circuitry within an optical network terminal (ONT) on a passive optical network (PON) when line power to the ONT is disabled;
powering a hibernation module within the ONT with supplemental power when the line power to the ONT is disabled, wherein the hibernation module monitors information transmitted to the ONT; and
re-activating a subset of the deactivated circuitry when the information transmitted to the ONT indicates a service critical event, wherein the re-activated circuitry is powered with the supplemental power.

2. The method of claim 1, wherein deactivating circuitry within an ONT in the PON comprises deactivating an optical receiver, an optical transmitter, processing circuitry, data circuitry, video circuitry, and telephone circuitry, and wherein re-activating the subset of the deactivated circuitry comprises re-activating the optical receiver to receive the information transmitted to the ONT, re-activating the processing circuitry to determine if the received information indicates the service critical event, and re-activating the optical transmitter and the telephone circuitry to support voice communication of voice information to an optical line terminal (OLT) on the PON.

3. The method of claim 1, wherein the service critical event comprises an incoming phone call.

4. The method of claim 1, wherein the hibernation module monitors information transmitted to the ONT at one or more selected intervals.

5. The method of claim 4, wherein the selected intervals comprise substantially periodic intervals.

6. The method of claim 4, wherein the selected intervals are approximately two seconds apart from one another.

7. The method of claim 1, wherein the hibernation module monitors information transmitted to the ONT to determine if the information is intended for the ONT.

8. The method of claim 7, wherein the hibernation module determines if the information is intended for the ONT by comparing an identifier associated with the information to an identifier associated with the ONT.

9. The method of claim 8, wherein the identifier associated with the ONT comprises one of a network address and a media access control (MAC) address.

10. The method of claim 1, wherein the hibernation module monitors information transmitted to the ONT by temporarily re-activating the subset of the deactivated circuitry to receive the information and determining if the received information indicates the service critical event.

11. The method of claim 10, wherein the information transmitted to the ONT comprises an upstream grant and wherein the hibernation module determines if the information indicates a service critical event by determining if the upstream grant includes one of an overloaded upstream bandwidth map and a physical layer operations, administration, and maintenance (PLOAM) packet with an embedded message associated with a service critical event.

12. The method of claim 1, wherein re-activating the subset of the deactivated circuitry comprises re-activating the subset of the deactivated circuitry to support communication of voice information to an optical line terminal (OLT) on the PON when the information transmitted to the ONT indicates an incoming phone call and deactivating the re-activated circuitry after completing the voice communication.

13. The method of claim 1, wherien the supplemental power comprises battery power.

14. A method comprising:
deactivating circuitry within an optical network terminal (ONT) on a passive optical network (PON) when line power to the ONT is disabled;
powering a hibernation module within the ONT with supplemental power when the line power to the ONT is disabled, wherein the hibernation module monitors a subscriber telephone line coupled to the ONT to identify an outgoing telephone call; and
re-activating a subset of the deactivated circuitry in response to the hibernation module identifying the outgoing telephone call, wherein the re-activated circuitry is powered with the supplemental power.

15. The method of claim 14, wherein deactivating circuitry comprises deactivating one or more of an optical receiver, an optical transmitter, processing circuitry, data circuitry, video circuitry, and telephone circuitry, and wherein re-activating the subset of the deactivated circuitry comprises re-activating the optical receiver to receive the information transmitted to the ONT and re-activating one or more of the optical transmitter, the processing circuitry, and the telephone circuitry to support voice communication of voice information to an optical line terminal (OLT) on the PON.

16. The method of claim 14, wherein the hibernation module monitors current on the subscriber telephone line to identify an outgoing telephone call.

17. The method of claim 14, wherein re-activating the subset of the deactivated circuitry comprises re-activating the subset of the deactivated circuitry to support communication of voice information to an optical line terminal (OLT) on the PON when the hibernation module identifies an outgoing telephone call and deactivating the re-activated circuitry after completing the voice communication.

18. The method of claim 14, wherien the supplemental power comprises battery power.

19. A method comprising:
deactivating circuitry within an optical network terminal (ONT) on a passive optical network (PON) when line power to the ONT is disabled;
powering a hibernation module within the ONT with supplemental power when the line power to the ONT is disabled, wherein the hibernation module monitors information transmitted to the ONT; and
re-activating a subset of the deactivated circuitry to confirm operational status of the ONT when the information transmitted to the ONT indicates a network maintenance communication with an optical line terminal (OLT) on the PON, wherein the re-activated circuitry is powered with the supplemental power.

20. The method of claim 19, wherein deactivating circuitry within the ONT comprises deactivating at least one of an optical receiver, an optical transmitter, processing circuitry, data circuitry, video circuitry, and telephone circuitry, and wherein activating the subset of the deactivated circuitry comprises re-activating the optical receiver to receive the information transmitted to the ONT, re-activating the processing circuitry to determine when to transmit the network maintenance communication to the OLT on the PON, and re-activating the optical transmitter to transmit the maintenance communication to the OLT on the PON.

21. The method of claim 19, wherein the hibernation module monitors information transmitted to the ONT at one or more selected intervals.

22. The method of claim 21, wherein the selected intervals comprise substantially periodic intervals.

23. The method of claim 21, wherein the selected intervals are approximately five seconds apart from one another.

24. The method of claim 19, wherein the hibernation module monitors information transmitted to the ONT to determine if the information is intended for the ONT.

25. The method of claim 24, wherein the hibernation module determines if the information is intended for the ONT by comparing an identifier associated with the information to an identifier associated with the ONT.

26. The method of claim 25, wherein the identifier associated with the ONT comprises one of a network address and a media access control (MAC) address.

27. The method of claim 19, wherein re-activating the subset of the deactivated circuitry comprises temporarily re-activating the subset of the deactivated circuitry to transmit a maintenance communication to the OLT on the PON and deactivating the re-activated circuitry after transmitting the network maintenance communication.

28. The method of claim 19, wherein the information comprises one of an upstream grant that includes one of a upstream bandwidth map and a physical layer operations, administration, and maintenance (PLOAM) packet.

29. The method of claim 19, wherien the supplemental power comprises battery power.

30. An optical network terminal (ONT) for use on a passive optical network (PON) comprising:
circuitry that is deactivated when line power to the ONT is disabled;
a hibernation module that deactivates the circuitry when line power to the ONT is disabled, monitors information transmitted to the ONT to detect a service critical event, and re-activates a subset of the deactivated circuitry in response to detecting the service critical event; and
a battery to supply battery power to the hibernation module and the re-activated circuitry when the line power to the ONT is disabled.

31. The ONT of claim 30,
wherein the deactivated circuitry supports communication of information over the PON and comprises one or more of an optical receiver, an optical transmitter, processing circuitry, data circuitry, video circuitry, and telephone circuitry, and
wherein the hibernation module re-activates the subset of the deactivated circuitry, the subset of the deactivated circuitry comprising at least one of the optical receiver, the optical transmitter, the processing circuitry, and the telephone circuitry.

32. The ONT of claim 30, wherein the hibernation module comprises:
a preamble comparator that monitors information transmitted to the ONT to determine if the information is intended for the ONT and detects the service critical event and; and
and an incoming transmission monitor that activates a wake-up circuit in response to the preamble comparator detecting the service critical event, wherein the wake-up circuit temporarily re-activates the subset of deactivated circuitry, and wherein the subset of the deactivated circuitry comprises at least one of the optical receiver, the optical transmitter, the processing circuitry, and the telephone circuitry.

33. The ONT of claim 30,
wherein the service critical event comprises an incoming phone call,
wherein the hibernation module re-activates the subset of the deactivated circuitry to support communication of voice information to an optical line terminal (OLT) on the PON, and
wherein the hibernation module deactivates the re-activated circuitry after completing the voice communication.

34. The ONT of claim 30,
wherein the service critical event comprises confirming an operational status of the ONT, wherein the hibernation module activates the subset of the deactivated circuitry to transmit a network maintenance communication to an optical line terminal (OLT) on the PON to confirm the operational status of the ONT, and wherein the hibernation module deactivates the re-activated circuitry after transmitting the network maintenance communication.

35. The ONT of claim 32, wherein the preamble comparator determines if the information is intended for the ONT by comparing an identifier associated with the information to an identifier associated with the ONT.

36. The ONT of claim 30, wherein the hibernation module comprises:
a preamble comparate to monitor information transmitted to ONT at selected intervals; and
a synchronized counter to track and select the intervals.

37. The ONT of claim 36, wherein the synchronized counter selects the intervals to be substantially periodic.

38. The ONT of claim 32, wherein the hibernation module further comprises a watchdog timer to activate the wake-up circuit based on the selected intervals.

39. The ONT of claim 30,
wherein the service critical event comprises an outgoing phone call,
wherein the hibernation module comprises a sensor that monitors current on a subscriber telephone line coupled to the ONT to detect an occurance of an outgoing phone call, re-activates the subset of the deactivated circuitry to support communication of voice information to an optical line terminal (OLT) on the PON, and deactivates the re-activated circuitry after completing the voice communication.
